(19) United States
(12) Patent Application Publication
(10) Pub. No.: US 2026/0252203 A1
(43) Pub. Date: Aug. 27, 2026

(54) DYNAMIC WINDOW GENERATION BASED ON A DEFINED AREA OF INTEREST

(71) Applicant: Motorola Mobility LLC, Chicago, IL (US)

(72) Inventors: Amit Kumar Agrawal, Bangalore (IN); Krishnan Raghavan, Bangalore (IN); Nakul Patel, Bangalore (IN)

(73) Assignee: Motorola Mobility LLC, Chicago, IL (US)

(21) Appl. No.: 19/065,802

(22) Filed: Feb. 27, 2025

(51) Int. Cl. G06F 3/0481; G06F 3/0484; G06F 3/0488; G06F 9/451

(52) U.S. Cl. CPC G06F 3/0481; G06F 3/0484; G06F 3/0488; G06F 9/451

(57) ABSTRACT

Techniques for dynamic window generation based on a defined area of interest are described and are implementable to provide targeted information updates. For example, an input is received that defines a boundary around a portion of digital content displayed by an application. An area of interest of the digital content is determined based on the boundary that includes a dynamic visual component of the application. A background instance of the application is generated that includes the dynamic visual component. A window is generated output for display in a user interface that depicts information extracted from the dynamic visual component in the background instance of the application. The window is updated based on detected changes to the dynamic visual component. A termination condition of an event associated with the dynamic component is detected, and the window is automatically removed from display and execution of the background instance is terminated.

### BACKGROUND

Modern mobile devices offer users access to a wide array of digital content and applications. These applications often display dynamic information that updates in real-time, such as sports scores, stock prices, or transportation schedules. However, accessing this information typically involves manual navigation through multiple screens while running multiple applications in a foreground of a device, which can be cumbersome and disruptive to other tasks. Additionally, repeated navigation between applications and refreshing screens to view updated information can lead to increased battery consumption and excessive data usage. Further, many applications present more information than a user may want to monitor at a given time, which creates visual clutter and makes it challenging for the user to focus on particular data points which degrades a user experience. These limitations impact an efficiency and convenience with which users interact with and consume dynamic digital content on respective devices.

### BRIEF DESCRIPTION OF THE DRAWINGS

Aspects of dynamic window generation based on a defined area of interest are described with reference to the following Figures. The same numbers may be used throughout to reference similar features and components that are shown in the Figures:

FIG. 1 illustrates an example environment in which aspects of dynamic window generation based on a defined area of interest can be implemented.

FIG. 2 depicts an example system for dynamic window generation based on a defined area of interest in accordance with one or more implementations.

FIGS. 3a-3d depict example implementations for dynamic window generation based on a defined area of interest in accordance with one or more implementations.

FIGS. 4a-4g depict example implementations for dynamic window generation based on a defined area of interest in which the window is based in part on a prompt in accordance with one or more implementations.

FIG. 5 illustrates a flow chart depicting an example method for dynamic window generation based on a defined area of interest in accordance with one or more implementations.

FIG. 6 illustrates various components of an example device in which aspects of dynamic window generation based on a defined area of interest can be implemented.

### DETAILED DESCRIPTION

Techniques for dynamic window generation based on a defined area of interest are described. The described implementations support creation of customized windows that display discrete information extracted from dynamic visual components of applications. For instance, the described implementations enable users to define an area of interest within an application interface by drawing a boundary around a portion of digital content. The system then generates a quick-view window that displays information extracted from the defined area and updates the area in real-time based on changes in the underlying application, which is maintained as a “background” application. In this way, the techniques described herein support efficient monitoring of particular data features without a burden to keep applications open, reducing device resource usage and improving a user experience.

For instance, a client device receives a user input that defines a boundary around a portion of digital content displayed by an application. Consider an example in which the application is a sports application that depicts live updates for a particular game on the client device. The application depicts a variety of information that is updated throughout the game, such as scores, statistics for various players, events that transpire throughout the game, and so forth. A user of the application wishes to receive updates on statistics for a particular player on a particular team. Accordingly, the user input includes an action to “circle” a region of the application that depicts statistics associated with the particular player such as via a touch gesture or stylus input.

The client device then determines an area of interest that includes a dynamic visual component of the application based on the defined boundary. Continuing with the above example, the area of interest includes a portion of the application that is updated to depict the statistics of the particular player. In some examples, the client device does so by correlating the boundary to objects represented in the application document object model and/or by leveraging one or more visual recognition algorithms to refine the user selection. In this way, the client device accounts for potential imprecisions in the user input.

Once the area of interest is determined, the client device generates a background instance of the application. The background instance allows the client device to monitor changes in the area of interest without continued foreground execution of the application. Accordingly, the techniques described herein conserve system resources by ceasing execution of computationally expensive operations to render the application content for display.

The client device then generates a window for display in a user interface that depicts information extracted from the dynamic visual component. The window, for instance, is a condensed graphical user interface element that provides quick access to particular functionality and/or specific information. The window can be displayed in various locations of the user interface, such as on a home screen, lock screen, notification center, and so forth. In some cases, the window includes a widget that can be displayed as an overlay on top of other applications or content, which enables users to view the extracted information without interruption of an ongoing task. Position, size, and display options for the window may further be customizable to integrate with user specific preferences and usage patterns. Continuing the above example, the window includes a widget that depicts statistics of the particular player.

The client device is operable to update the window, such as by streaming content from the background instance of the application. For instance, the client device monitors the dynamic visual component within the background instance for changes or updates. When the client device detects an update to the dynamic visual component, the updated information may be extracted and processed for display by the window. The processed data is then transmitted or “streamed” to the window to depict the updated information in real-time.

In the context of the above example, the client device monitors the statistics for the particular player within the background instance of the application. As the game progresses and the statistics change, the client device detects these updates in real-time. The updated statistics are then extracted from the background instance, processed to fit the format of the widget, and streamed to the widget for output. Thus, the client device displays current player statistics on the widget without foreground execution of the sports application open or manual intervention to refresh the application for updates. The widget may be dynamically updated throughout the game, which provides a seamless and efficient way for the user to track desired player performance metrics while engaging in other activities on the device.

The client device is further configured to detect termination conditions associated with the event or content being monitored. In the example, the client device monitors for application behavior that indicates an end of the game has been reached. This can include detection of a final score, a specific time elapsed, or a particular status update within the background instance of the application. When such a termination condition is detected, the client device initiates a series of cleanup operations to efficiently manage system resources.

For instance, upon detection of the termination condition, the client device automatically removes the window from display in the user interface. This ensures that outdated or irrelevant information is not displayed. Further, the client device terminates the background instance of the application, which frees up system resources that were being used to monitor and update the window. In some implementations, the client device may provide a notification to the user about the event conclusion and/or window removal. These automated termination processes help maintain an uncluttered user interface and optimize device performance by eliminating unnecessary background processes.

Accordingly, the techniques described herein overcome conventional limitations by providing a customizable approach to information monitoring and display. By generating windows that depict information included in user-defined areas of interest within applications, these techniques reduce cognitive load and minimize distractions associated with processing large amounts of dynamic content. The generation of customized windows based on user-selected content areas further enhances device efficiency by eliminating foreground execution of computationally expensive applications. In this way, these techniques support improved battery life and reduced data usage, as relevant information is continuously updated while extraneous information is not processed. Further, automatic termination of windows and background processes helps maintain efficient device performance. Thus, these techniques offer an intuitive, efficient, and personalized way for users to interact with dynamic digital content on devices, and address challenges of information overload and resource management in modern mobile computing environments.

While features and concepts of dynamic window generation based on a defined area of interest can be implemented in any number of environments and/or configurations, aspects of dynamic window generation based on a defined area of interest are described in the context of the following example systems, devices, and methods.

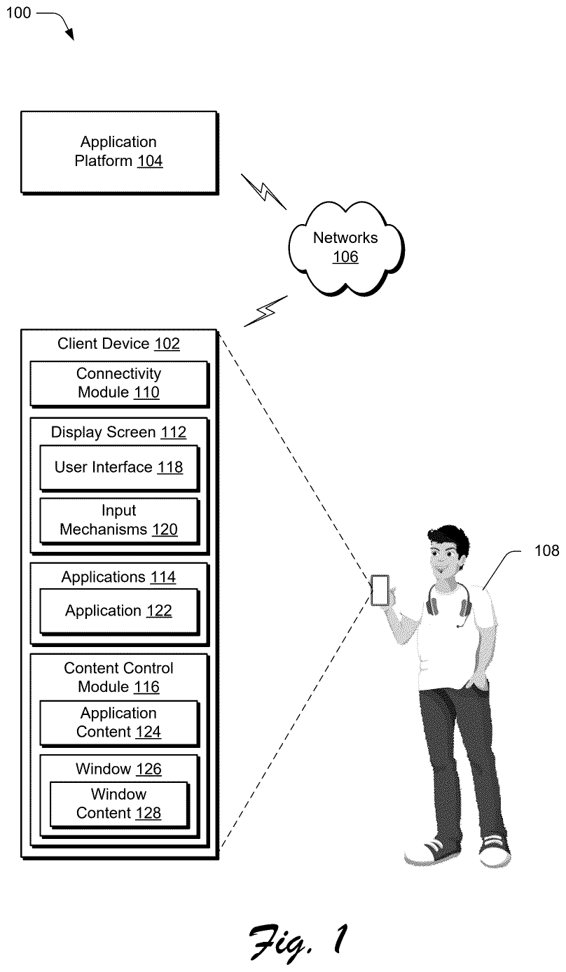

FIG. 1 illustrates an example environment 100 in which aspects of dynamic window generation based on a defined area of interest can be implemented.

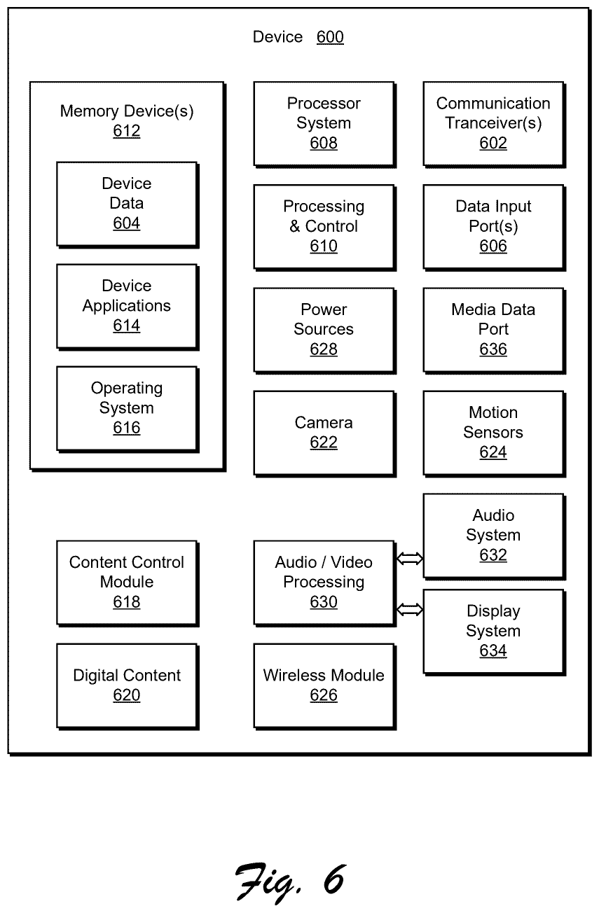

The environment 100 includes a computing device such as a client device 102 and a network-based application platform 104 that are interconnectable via network(s) 106. In the illustrated example, the client device 102 is depicted as a portable device that can be carried by a user 108, however this is by way of example and not limitation. The client device 102 can be implemented in a variety of different ways and form factors such as a smartphone, a tablet device, a laptop computer, desktop computer, a wearable computing device, (e.g., a smartwatch or a fitness tracker), augmented reality (“AR) and/or virtual reality (“VR”) devices (e.g., AR/VR glasses, projectors, headsets, etc.), a docked mobile device connected to a monitor, and so forth. Example attributes of the client device 102 are discussed below with reference to the device 600 of FIG. 6.

The application platform 104 may include a variety of network-based services and/or applications that enable users to create, upload, share, and/or interact with various digital content. In some aspects, the application platform 104 may include various components and functionality to support operation of various applications. Such components may include data storage systems, content delivery networks, user authentication services, analytics engines, and application programming interfaces (APIs) that enable third-party developers to integrate with the application platform 104. In some implementations, the application platform 104 may utilize cloud computing resources to provide flexible and scalable infrastructure for hosting applications and managing user data.

The application platform can support operation of a variety of applications, such as social networking platforms, content sharing services, productivity tools, messaging applications, gaming platforms, e-commerce systems, educational platforms, financial management tools, travel planning services, health and fitness trackers, news aggregators, weather forecasting applications, and various other types of software applications and services. The platform may support various types of digital content, including but not limited to text posts, images, videos, audio files, hyperlinks, videos, AR/VR content, interactive media, etc. In various aspects, the application platform 104 may support multiple device types and operating systems, enabling users to access and interact with application content across desktop computers, mobile devices, and other internet-connected devices. It should be understood that in various aspects, the application platform 104 may perform same or substantially similar functionality as the client device 102 and the client device 102 is likewise capable of performance of same or substantially similar functionality as the application platform 104.

The application platform 104 may further include various components and services to support dynamic window generation and content management. In some implementations, the application platform 104 may comprise one or more server systems, cloud-based infrastructure, or distributed computing resources. The platform may incorporate data storage capabilities, such as databases or content repositories, to manage user data, application data, and/or window configurations. In some aspects, the application platform 104 may include processing modules for analyzing user interactions, generating windows based on defined areas of interest, and managing real-time data updates. The platform may also provide APIs or software development kits (SDKs) to enable integration with third-party applications and services. Additionally, the application platform 104 may include security features, user authentication mechanisms, and tools for customizing the user experience across different devices and form factors.

The client device 102 includes various functionality and components that enable the client device 102 to perform different aspects of dynamic window generation based on a defined area of interest as discussed herein, including a connectivity module 110, a display screen 112, one or more applications 114, and a content control module 116. The connectivity module 110 represents functionality (e.g., logic and hardware) for enabling the client device 102 to interconnect with other devices and/or networks, such as the application platform 104 and/or the network 106. The connectivity module 110, for instance, enables wireless and/or wired connectivity of the client device 102, such as to transmit digital content between the client device 102, the application platform 104, and/or one or more additional devices such as connected display devices, smart watches, other mobile devices, and so forth.

The display screen 112 represents functionality (e.g., hardware and logic) for enabling visual output via the client device 102, for instance, via a user interface 118. The user interface 118, for instance, includes one or more visual, auditory, and/or tactile elements that enable the user 108 to interact with digital content displayed by the client device 102. The display screen 112 and the user interface 118 are configurable with a variety of settings, such as display settings (e.g., resolution, aspect ratio, refresh rate, contrast, color profile, scaling, orientation), processing settings (e.g., upscaling/downscaling, image processing modes, computational resources usage and delegation, refresh rate, power-saving modes, overdrive settings to increase pixel response times, etc.), and/or interface settings, e.g., menu layouts, navigation, language settings, on-screen display settings, input sensitivity and responsiveness, theme, selectable indicia positioning and/or sizing, accessibility settings, input method customizations, etc.

In various examples, the display screen 112 further includes one or more input mechanisms 120. The input mechanisms 120 represent functionality for enabling input to the client device 102, such as user input to invoke functionality of the client device 102. The input mechanisms 120 can include functionality for receiving proximity-based input to the client device 102, such as stylus input, user touch input, contactless input based on proximity of a user's finger and/or a stylus to the client device 102, and so forth. In various examples, the input mechanisms 120 include one or more touch sensors and/or touch screens. This is by way of example and not limitation, and the input mechanisms 120 can include and/or support one or more of a virtual keyboard, voice input components, environmental sensors, motion gestures, biometric sensors, etc.

The one or more applications 114 represent functionality for performing different computing tasks via the client device 102, such as social media and/or content sharing, messaging and/or communication, gaming (e.g., mobile and/or touch-based gaming), media consumption (e.g., content streaming), productivity tasks (e.g., word processing, content generation, data analysis, etc.), web browsing, interaction with other devices, event viewing and/or monitoring, financial and so forth. In some aspects, the client device 102 may download and install the applications 122 from the application platform 104, with the application platform 104 providing updates, data synchronization, and backend services to support functionality of the applications 114 on the client device 102.

The applications 114, for instance, include an application 122 to perform one or more tasks. The application 122 may be configured to cause the client device 102 to display various application content 124, e.g., dynamic content that updates in real-time and/or at regular or periodic intervals. In some aspects, the application content 124 may include various sections of an interface of the application 122 that are dynamically updated as underlying data related to the sections changes. For example, the application 122 may display application content 124 such as live information feeds, real-time data visualizations, automatically refreshing lists or tables, and/or sections for live commentary or analysis. These dynamic areas within the application 122 may be updated at different intervals or in response to specific events or data changes. The application 122 may retrieve this information from the application platform 104 or other data sources, such as to ensure that users have access to current and relevant data.

The content control module 116 represents functionality for performing various aspects of dynamic window generation based on a defined area of interest as described herein. As described in more detail below, the content control module 116 is operable to generate a dynamic window, e.g., a window 126, that depicts information extracted from a discrete region of the application content 124 such as based on an input to define the region. In this way, the window 126 provides convenient access to monitor desired information without reliance on maintaining the full application 122, which reduces device resource usage and improves an overall user experience.

The window 126, for instance, represents an interface element that displays specific information extracted from the application content 124. In some aspects, the window 126 may be a compact, self-contained graphical component that can be positioned on the user interface 118 independently of the application 122. The window 126 is configurable to update dynamically to reflect changes in the underlying data it represents, such as to provide users with real-time information without a need to keep the application 122 open or visible. In various implementations, the window 126 may be customizable, allowing users to adjust an appearance, size, and/or specific data the window 126 displays. The window 126 may also include one or more interactive elements such as one or more widgets that enable users to perform certain actions or access additional information directly through the widget interface.

In various examples, the window 126 depicts window content 128. The window content 128, for instance, refers to information or data extracted from a dynamic region of the application 122 and configured for display by the window 126. This content may include real-time updates, statistics, scores, and/or other relevant information that is subject to various updates. The window content 128 is adapted for display by the window 126 from the application content 124, such as to provide clear visual access to relevant information without navigation to the application 122. As underlying data in the application 122 changes, the window content 128 is updated accordingly to reflect the changes.

By way of example, the content control module 116 may receive an input from the user 108 to define an area of interest within the application content 124. For instance, the user 108 may use a touch gesture, stylus input, or other input mechanism 120 to draw a boundary around a specific portion of the application content 124 displayed on the display screen 112. The content control module 116 may then analyze this input to determine a precise region within the application content 124.

Based on the specified region, the content control module 116 may generate the window 126. This process may involve extraction of relevant information from the specified region of the application content 124, processing the information to fit a format of the window 126, and creating a standalone window interface that depicts the window content 128. The window 126 may then be displayed in the user interface 118, such as in a different location or a different screen than the original application content 124.

As the underlying data in the application 122 is updated, the content control module 116 may continuously monitor these changes. In at least one example, the content control module 116 causes the client device 102 to continue execution of the application 122 in a background, such as to conserve computational resources otherwise used to process, output, and/or display the application content 124. When relevant updates occur within the defined region of the application content 124, the content control module 116 may automatically update the window content 128 to reflect these changes. This allows presentation of specified information without the computational burden to keep the full application 122 open or visible. In this way, the techniques described herein enhance user productivity, reduce device resource consumption, and provide a personalized and efficient modality for users to interact with and monitor specific information from various applications 122.

Having discussed an example environment in which the disclosed techniques can be performed, consider now some example scenarios and implementation details for implementing the disclosed techniques.

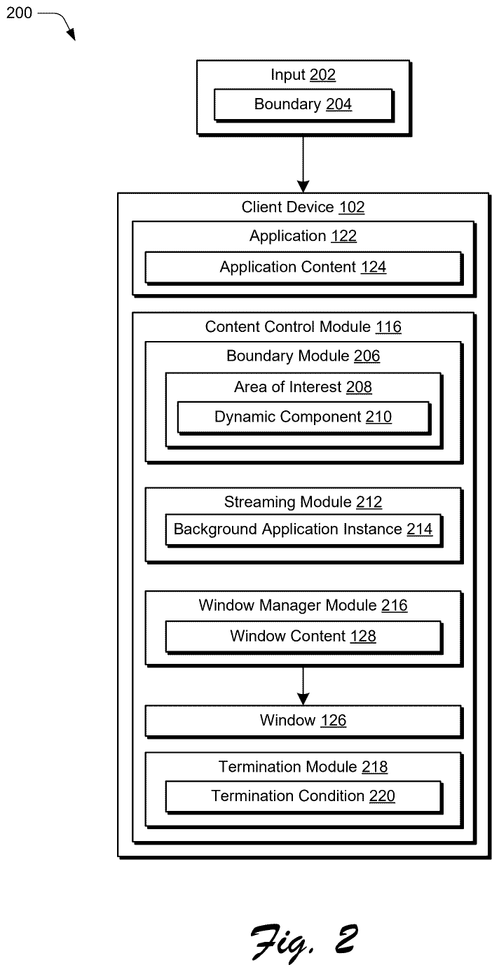

FIG. 2 depicts an example system 200 for dynamic window generation based on a defined area of interest in accordance with one or more implementations. The system 200 can be implemented in the environment 100 and incorporates attributes of the environment 100 introduced above. Generally, the content control module 116 is configurable to manage display of a dynamic window 126 that depicts information extracted from a defined region of an application 122.

For example, the content control module 116 receives an input 202 that defines a boundary 204 around a portion of application content 124 displayed by an application 122 on a client device 102. The application 122 can display a variety of content and can include one or more of a web browser, a native mobile application, a desktop program, etc. In various examples, the application 122 is representative of an operating system of the client device 102 and the application content 124 can include a home screen, notification center, device settings, system menus, etc. The content control module 116 is operable to work across various types of applications 114 to provide a consistent user experience regardless of an underlying application architecture.

In some examples, the input 202 may include a gesture that approximately encloses a portion of area on a display of the client device 102. The input 202, for instance, represents a user-initiated action to select a particular region of interest within the application content 124. This input can be performed through various modalities supported by the client device 102, such as proximity-based input, touch gestures on a touchscreen, stylus input, verbal commands, one or more strokes, mouse clicks and/or drags, or one or more contactless gestures detected by proximity sensors. This is by way of example and not limitation, and a variety of input mechanisms 120 are considered.

The boundary 204 created by the input 202 serves as a visual indicator of a region of interest, e.g., a region of the application content 124 that is to be represented by a window 126. The system is designed to recognize and interpret a variety of enclosed shapes. This could include rectangles, ovals, freeform shapes, or a variety of approximately closed contours. In an example, the region of application content 124 encompassed by the boundary 204 contains dynamic information that the user 108 wishes to monitor or access frequently. In one or more implementations, this includes a specific data point, a group of related information, and/or a section of the application that is regularly updated. By allowing users to define this region, the system 200 enables a highly personalized and focused interaction with the applications content 124.

The content control module 116 includes a boundary module 206 that is operable to process the user input 202 to determine an area of interest 208 within the application content 124. The area of interest 208, for example, includes a dynamic component 210, which represents a specific portion of the application content 124 that updates or changes over time. The dynamic component 210 may include various visual and/or non-visual elements such as real-time data feeds, automatically refreshing information, live statistics, or content that is subject to periodic or event-driven modifications within an application interface. The dynamic component 210 may represent particular information or visual elements that a user wishes to monitor or access frequently without navigation through an interface of the application 122, which can be tedious and utilize unnecessary processing resources of the client device 102.

The boundary module 206 interprets the input 202 (e.g., gesture, touch, stroke, or other form of interaction) to determine and/or modify a boundary 204 of the selected region. The boundary module 206 is operable to analyze application content 124 within and/or adjacent to the boundary 204 to identify the area of interest 208 and/or the dynamic component 210. For instance, the boundary module 206 is configurable to adjust the boundary 204, such as defined by a user 108, to align within content elements included in the application content 124. This process may involve examining a structure of the application 122, such as a document object model (DOM) associated with the application content 124, and/or implementation of one or more visual recognition algorithms to accurately map the boundary 204 to corresponding application elements to resolve imprecisions in the input 202.

For instance, boundary module 206 utilizes a document object model (DOM) associated with the application 122 to determine the area of interest 208. The document object model, for instance, includes a hierarchical representation of the structure and content of the application content 124. For example, the document object model provides of structured representation of objects, elements, attributes, and/or text within the application content 124. Accordingly, the boundary module 206 is able to correlate the boundary 204 to one or more objects represented by the document object model.

For instance, the boundary module 206 analyzes the document object model to identify UI elements and/or content structures within and/or adjacent to boundary 204. The boundary module 206 correlates spatial coordinates of the boundary 204 to corresponding spatial positions (e.g., coordinates) of objects included in the document object model. This allows the boundary module 206 to map the user selection to particular objects and/or data fields within the application structure to identify a likely area of interest 208 and/or a dynamic component 210.

As an example of this functionality, consider a scenario where the application 122 is a sports application that displays live match statistics. An input 202 is received that includes a user drawn spline to define a boundary 204 that partially encloses a statistic for a particular player, e.g., the spline does not “perfectly” enclose the desired statistic. The boundary module 206 is operable to analyze the document object model associated with the application content 124 to identify that coordinates of the boundary 204 are within a threshold distance to a data field for a current score of the particular player. By correlating the spatial coordinates of the input 202 to a known location (e.g., coordinates of) the structured representation in the DOM, the boundary module 206 can accurately determine that the user is interested in tracking the score of the particular player, despite inaccuracies in the input 202. The boundary module 206 is then able to adjust the boundary 204 to correspond to the data field.

The boundary module 206 may further employ one or more visual recognition algorithms to determine the area of interest 208. A visual recognition algorithm, for instance, includes a computational process that analyzes application content 124 to identify, locate, classify, and/or interpret visual elements. These algorithms may employ various techniques such as pattern matching, feature extraction, machine learning models, artificial intelligence, and/or neural networks to process visual information and make determinations about the content. Accordingly, the boundary module 206 can leverage a visual recognition algorithm to detect and correlate visual properties of one or more objects included in the application content 124 to a location of the boundary 204. In this way, the boundary module 206 may identify objects included in the application content 124 that are adjacent to and/or within the boundary 204 that likely correspond to the area of interest 208 and/or a dynamic component 210.

The visual recognition algorithms employed by the boundary module 206 may utilize various advanced techniques to accurately identify and interpret the content within and/or adjacent to the boundary 204. These techniques can include edge detection to precisely outline objects, color analysis to distinguish between different elements, and/or text recognition to extract and interpret textual information present in the application content 124. Additionally, the algorithms may employ contextual analysis and consider relationships (e.g., spatial, contextual, etc.) between different visual elements to understand an overall meaning and relevance of the selected area.

Consider an example in which a user is viewing an application 122 that depicts a multielement financial dashboard within a stock trading application. The dashboard displays multiple charts, stock tickers, and numerical data. An input 202 is received that includes a stroke to define a boundary 204 around a specific price chart and recent trading volume.

The boundary module 206 is operable to employ one or more visual recognition algorithms to analyze the selected area to resolve potential inconsistencies in the input 202. For instance, if a stroke does not fully enclose the price chart, the boundary module 206 can analyze the visual elements within and adjacent to the incomplete boundary to infer an intended selection. For instance, the boundary module 206 may identify edges of the price chart and trading volume display, then adjust the boundary 204 to precisely encompass these elements. Additionally, if the stroke overlaps multiple elements, the boundary module 206 can assess which elements are predominantly within the selection and refine the boundary 204 accordingly. This intelligent boundary adjustment helps ensure that the system 200 captures an intended area of interest 208 accurately, even in an example in which the initial input 202 is imprecise.

A streaming module 212 of the content control module 116 is operable to create and manage a background application instance 214 of the application 122. In one or more examples the background application instance 214 represents a version of the application 122 that runs in the background without being visibly presented in the user interface 118. The background application instance 214 is configured to allow the system 200 to monitor and extract data from the dynamic component 210 without the foreground execution of the application 122, e.g., without the application 122 “open” within the user interface 118. By running the application 122 in the background, the system 200 may reduce processing power and memory required for graphical operations. This approach may eliminate a demand for continuous screen refreshes and complex UI element rendering, which can be computationally expensive.

Additionally, the background application instance 214 may be configured to focus exclusively on monitoring and extracting data from the dynamic component 210. For instance, the streaming module 212 configures the background application instance 214 to disable processing of application elements extraneous to the dynamic component 210, thereby reducing computational overhead and improving efficiency in data extraction and processing. This targeted approach allows the system 200 to allocate resources efficiently, reduces CPU usage, memory consumption, and power draw compared to executing the full application 122 in the foreground.

The streaming module 212 is further operable to stream information from the background application instance 214. For instance, the streaming module 212 receives a query for information about the background application instance 214 and is operable to generate and communicate a response to the query. In this way, the streaming module 212 is usable to provide information and/or updates about the dynamic component 210 running in the background application instance 214, such as described in more detail below.

For instance, a widget manager module 216 of the content control module 116 may create a window 126 and configure window content 128 for display by the window 126. The window 126 represents a condensed graphical user interface element (e.g., a widget) that displays specific information extracted from the application content 124. In some implementations, the window 126 may be positioned on the user interface 118 independently of the application 122. The window 126 is configurable to update dynamically to reflect changes in the underlying data it represents (e.g., changes to the dynamic component 210) which provides users with current information without requiring the application 122 to remain open or visible. The window manager module 216 can cause output of the window 126, such as in the user interface 118, and/or can cause the window 126 to be communicated for display by one or more connected devices, e.g., an external display device, smartwatch, networked device, etc.

In some implementations, the widget manager module 216 may generate window content 128 for display by extracting and streaming information from the background application instance 214 and applying one or more modifications to the information to configure the information for display by the window 126. For example, the widget manager module 216 may extract relevant data from the background application instance 214, process and format that data to fit dimensions and style of the window 126, and continuously update the window content 128 as new information becomes available. This approach allows for real-time updates to be reflected in the window 126 while maintaining an efficient use of system resources, as the full application 122 is not rendered in the foreground.

The widget manager module 216 may also implement various data transformation techniques, such as scaling, cropping, or rearranging elements, to ensure the extracted information is presented within display constraints of the window 126. Additionally, the window manager module 216 may apply one or more filters or conditions to the streamed data, allowing for selective display of information based on user-defined criteria or system-determined relevance. The window manager module 216 further supports customization of the window 126, such as to support adjustment to aspects such as appearance, size, and/or specific data displayed. The window 126 may also include interactive elements that enable users to perform particular actions or access additional information directly through the window interface.

The window manager module 216 may update the window 126 in a variety of ways and in accordance with various procedures. For instance, the window manager module 216 may update the information extracted from the dynamic visual component at a predetermined temporal interval and/or rate. Additionally or alternatively, the window manager module 216 may update the window 126 responsive to a detected change to the dynamic visual component in the background instance of the application.

For example, the window manager module 216 updates the information extracted from the dynamic visual component at a predetermined temporal interval through various mechanisms. In some implementations, the window manager module 216 establishes a periodic refresh cycle and queries the background application instance 214 for updated data at fixed time intervals according to an update rate. These intervals may be configurable, allowing for adjustment based on various features such as a nature of the data being monitored and/or user preferences. For example, dynamic stock price updates may occur every few seconds, while relatively static weather information updates may occur hourly.

The window manager module 216 may also implement adaptive update intervals based on a frequency of detected changes in the dynamic component 210. If the module detects that the data represented by the dynamic component 210 changes relatively frequently, e.g., above a particular threshold, the window manager module 216 may decrease the interval between updates to provide more frequent updates. Conversely, if the data remains static for extended periods (e.g., longer than a particular threshold) the window manager module 216 may increase the update interval to conserve system resources with relatively less frequent updates.

In some implementations, the window manager module 216 may generate a predictability score for an application 122 and adjust an update rate for the window 126 based on the predictability score. The predictability score provides a quantification of how likely the data within the dynamic visual component is to change at regular intervals or in response to specific events. A relatively higher predictability score indicates that the data updates follow a relatively consistent pattern, while a relatively lower score suggests irregular and/or unpredictable updates. This score helps the system optimize update frequencies and resource allocation for monitoring the dynamic component 210.

For example, an application 122 displaying real-time transportation data may have a high predictability score due to a regular update pattern during operating hours. In this case, the window manager module 216 may set a relatively lower update frequency, as the data changes are relatively more predictable and consistent. Conversely, an application 122 showing live sports scores may have a lower predictability score due to the unpredictable nature of game events. For such an application, the window manager module 216 may implement a higher update frequency to ensure timely reflection of sudden score changes or game-altering events. This adaptive approach based on predictability scores may help balance a need for up-to-date information with efficient resource utilization across different types of dynamic content.

Additionally or alternatively, the window manager module 216 may update the window 126 responsive to a detected change to the dynamic visual component in the background instance of the application. For example, the window manager module 216 may continuously monitor the dynamic component 210 within the background instance for changes or updates. When new information is detected, it can be extracted and processed in real-time. The processed data may then be transmitted directly to the window 126, such as to support real time updates to the window content 128.

In at least one example, the window manager module 216 is configured to update the window 126 based on properties of detected changes in the dynamic visual component 210. For instance, the window manager module 216 may analyze properties such as relative magnitude or quantity of changes to determine whether an update is warranted.

In an example in which the application depicts stock tracking information, the window manager module 216 may be configured to update the window 126 when price changes exceed a certain percentage threshold. For example, if a stock price fluctuates by more than 5%, the module may trigger an immediate update to the window 126. Similarly, in a sports application, the window manager module 216 may update the window 126 when significant events occur, such as when a team scores or when a player achieves a notable statistic. This approach may allow the system to prioritize updates for meaningful changes while minimizing unnecessary updates for minor fluctuations, such as to conserve system resources and prevent notification fatigue.

The window manager module 216 may configure functionality of the window 126 based on user-specified prompts or conditions. In some implementations, the window manager module 216 may provide an interface for users to input custom prompts, specific criteria, and/or thresholds. For example, the window manager module 216 receives a prompt that includes a text string to “notify me if the stock price drops below $50” or “notify me if my favorite team scores.” The window manager module 216 may then process these prompts and configure the window 126 to monitor for the specified conditions. Responsive to occurrence of the conditions, the window 126 may be updated accordingly, and/or generate corresponding notifications.

In some cases, these notifications may include audio alerts. For instance, if the specified condition is met, the window manager module 216 may trigger an audio output through the client device 102, such as to provide an audible notification. This audio notification may be in addition to or instead of visual updates to the window content 128, allowing users to stay informed about changes without viewing the display screen 112.

A termination module 218 of the content control module 116 may monitor for a termination condition 220. For instance, the window manager module 216 may continue to update the window 126 until the termination condition 220 is detected. Once the termination condition 220 is detected, the termination module 218 can initiate a termination procedure., such as to remove the window 126 and/or terminate the background application instance 214.

The termination module 218 may monitor for a variety of termination conditions 220. For example, the termination module 218 may detect completion of an event associated with the application 122 and/or the dynamic component 210, such as the end of a sports match, a close of a stock market trading session, a particular transportation mode reaching a particular destination, an observed metric reaching a threshold, a health metric reaching a particular level, and so forth. Additionally or alternatively, the termination module 218 may monitor for user-specified time limits or thresholds.

In some implementations, the termination module 218 may analyze patterns in the data updates to identify when the dynamic component 210 has become static or updates have ceased for an extended period. The termination module 218 may also detect changes in the underlying application state, such as the application 122 being closed or losing network connectivity, which could indicate that further updates are no longer available. By considering multiple factors, the termination module 218 can make informed decisions about when to initiate cleanup procedures, balancing a demand for up-to-date information with efficient resource management.

In some implementations, the termination module 218 may detect a termination condition 220 based on changes in the application content 124 or application behavior. For instance, the termination module 218 may monitor the background application instance 214 for specific patterns or events that indicate the conclusion of a monitored activity. In a sports application scenario, the termination module 218 may analyze the application content 124 for indicators such as a “final score” display, a change in a user interface layout signifying the end of a match, or an appearance of post-game statistics within the application content 124.

Similarly, for a stock trading application, the termination module 218 may detect changes in the application behavior such as cessation of real-time price updates, a display of a market closure message, or a shift to after-hours trading information. For a transportation application, the termination module 218 may monitor for indicators that signify an end of a journey or completion of a transportation-related event. For instance, when tracking a specific flight, the termination module 218 may detect updates in the application content 124 that indicate the flight has landed, such as a change in flight status from “In Air” to “Landed” or the appearance of arrival information. By recognizing application-specific cues, the termination module 218 can initiate the termination procedure at an appropriate time, ensuring that system resources are efficiently managed and the user interface remains uncluttered once the monitored event or activity has concluded.

A variety of operations of the termination procedure are considered, and the termination procedure may include a series of coordinated actions to efficiently manage system resources and maintain a clean user interface 118. In some implementations, the procedure may involve removing the window 126 from the user interface 118, termination of the background application instance 214, and/or termination of associated memory or processing resources. The termination module 218 may also clear cached data related to the dynamic component 210, reset custom user preferences or conditions associated with the specific monitoring session, and/or update relevant system logs or usage statistics.

Additionally, the termination procedure may include generation of one or more notifications for output by the client device 102, connected devices, and/or secondary displays to cease displaying the window content 128, ensuring a consistent experience across a device ecosystem. In some examples, the termination module 218 may provide a notification to the user that indicates that monitoring has concluded, which may include a summary of relevant information or events captured during the monitoring period.

Accordingly, the techniques described herein overcome conventional limitations by providing a customizable approach to information monitoring and display. By generating windows 126 that depict information included in user-defined areas of interest within applications 114, these techniques enhance a user experience with processing large amounts of dynamic content. Generation of customized windows 126 based on user-selected content areas further enhances device efficiency by eliminating foreground execution of computationally expensive applications 114 and automatic termination of windows 126 and background processes. Thus, these techniques offer an intuitive, efficient, and personalized way for users to interact with dynamic digital content on respective processing devices.

In some implementations, the content control module 116 further includes error handling capabilities to ensure continuous operation of the system 200. Consider an example in which the system 200 encounters an error such as an unexpected crash of the background application instance 214. The content control module 116 is operable to automatically re-initialize the background application instance 214 and reconfigure the data capture process to maintain output of updated content by the window 126.

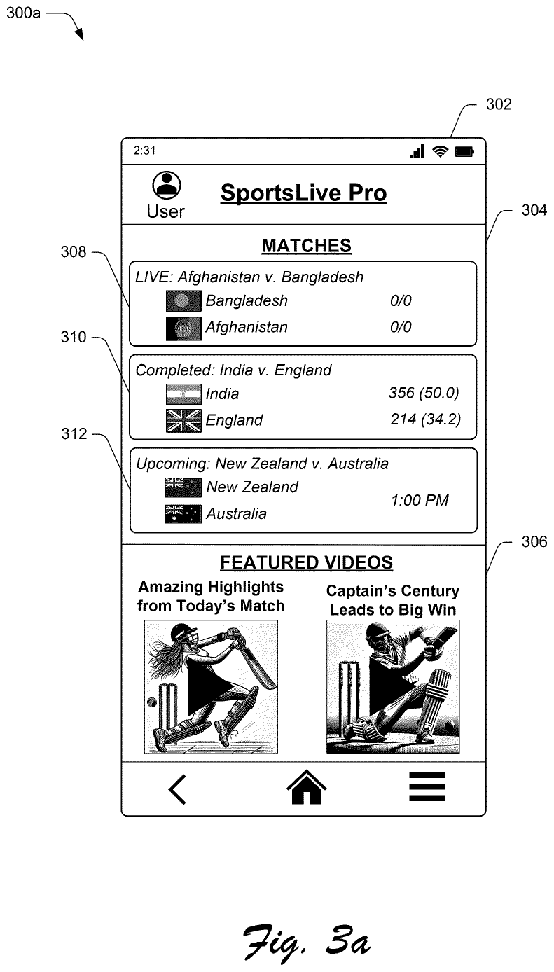

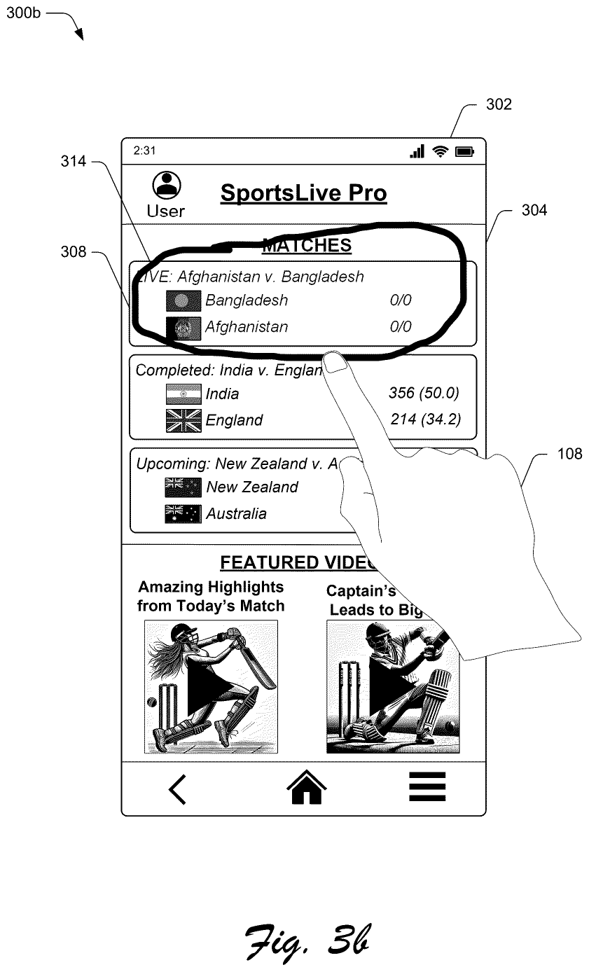

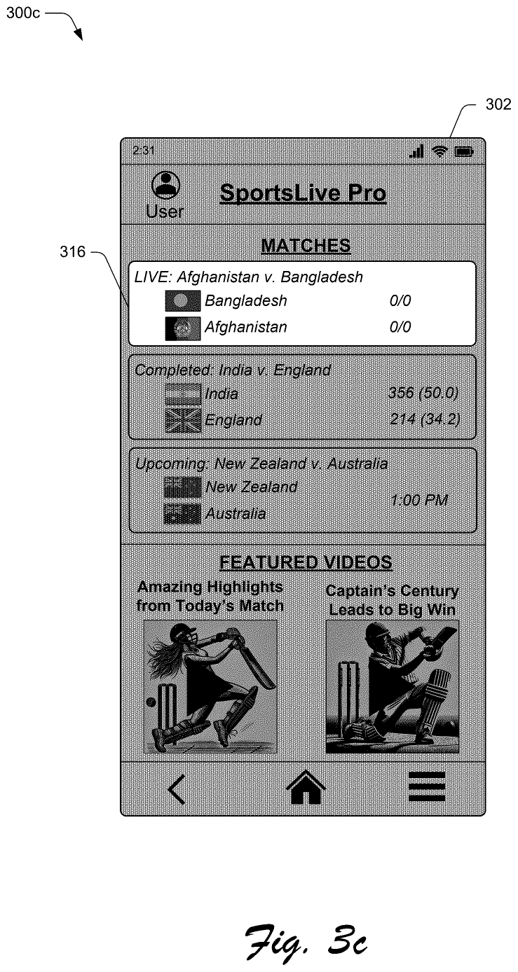

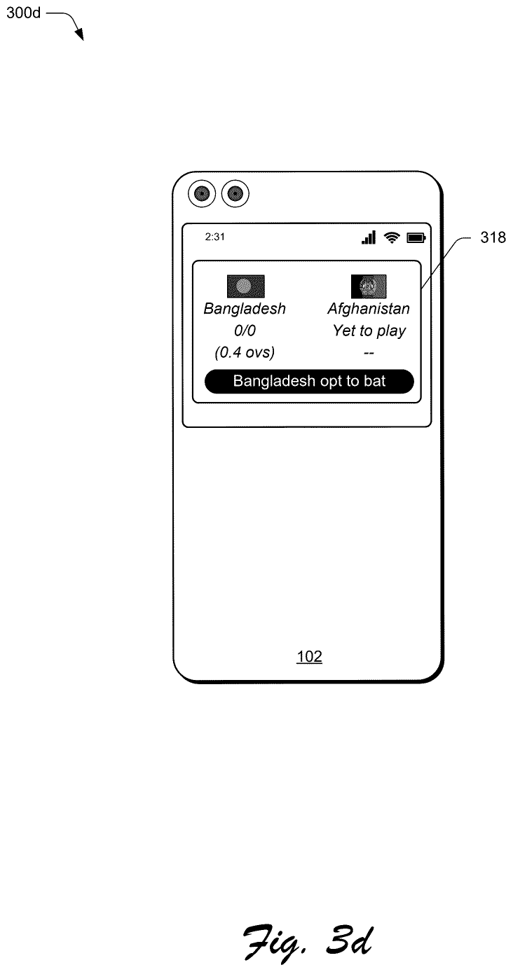

FIGS. 3a-3d depict example implementations 300a, 300b, 300c, and 300d for dynamic window generation based on a defined area of interest in accordance with one or more implementations.

To begin in this example, FIG. 3a depicts an example implementation 300a that includes an interface 302 of a sports application. The interface 302 depicts a variety of information, such as a matches section 304 and a featured videos section 306. The matches section 304 displays multiple match graphics, including a first match graphic 308, a second match graphic 310, and a third match graphic 312. Each match graphic represents a different sporting event, e.g., a different cricket match, and displays relevant information such as team names, scores, and match status.

In conventional systems, users face challenges to access specific information within an application. For instance, conventional techniques are reliant on manual navigation through multiple screens, menus, or tabs within the sports application to view a desired score or statistic. Thus, a user who desires updates on just the first match associated with the first match graphic 308 is forced to scroll through lengthy lists, expand various sections, and/or perform multiple taps and swipes to reach the relevant data. Such navigation can be time-consuming, inefficient, and utilize unnecessary computational resources. Thus, conventional approaches lead to increased user frustration, reduced efficiency, and higher battery consumption due to frequent interaction with the device and extended periods of application execution.

To overcome these limitations, the techniques described herein support dynamic window generation based on a defined area of interest which allows users to easily select and monitor specific information from within an application without time-intensive manual navigation or undue processing related to prolonged foreground execution of the application. To do so, FIG. 3b depicts an example implementation 300b in which the content control module 116 receives an input 202 from the user 108.

For instance, the user 108 desires to receive updates particular to the first match only. Accordingly, the input 202 includes a user input 314 to draw a boundary 204 around a portion of the application content 124 displayed in the interface 302. In this example, the user input 314 includes an action to draw the boundary 204 around the first match graphic 308 using the input mechanisms 120, e.g., a touch screen, of the client device 102. As illustrated, the user input 314 intersects a portion of the first match graphic 308 in several locations.

FIG. 3c depicts an example implementation 300c in which the boundary module 206 determines an area of interest 316 based on the boundary 204. The boundary module 206 may adjust the boundary 204 to align with content elements displayed within the boundary 204. For instance, the boundary module 206 may analyze a document object model of the application 122 and/or one or more visual recognition algorithms to identify UI elements that are spatially consistent with the user input 314.

For example, the boundary module 206 may leverage visual recognition algorithms to analyze the content within and adjacent to the user-drawn boundary 204. These algorithms may identify visual elements such as team logos, score displays, and match status indicators within the interface 302 that are within a threshold distance of the boundary 204. By combining this visual analysis with the document object model information, the boundary module 206 may accurately determine the area of interest 316 despite imprecisions present in the user input 314. For instance, while the user input 314 partially intersects elements within the first match graphic 308, the boundary module 206 may expand the area of interest 316 to fully include these elements, ensuring that relevant information from the first match graphic 308 is captured for subsequent monitoring and display in the window 126.

FIG. 3d depicts an example implementation 300d in which the window manager module 216 configures window content 318 for display in a window 126. In this example, the window 126 is a widget displayed on a rear display of the client device 102. The window manager module 216 may extract relevant information from the area of interest 316, such as the current score and match status, and format this information for display as the window content 318.

In accordance with the techniques described herein, the window manager module 216 may stream the window content 318 to the rear display of the client device 102, providing the user 108 with easy access to real-time updates without navigation to the full application interface 302. Additionally, the window manager module 216 may configure the window 126 to be streamed to a secondary device, such as a secondary display within the client device 102 and/or a companion device such as a smartwatch or smart speaker. This flexibility allows the user 108 to monitor the sporting event statistics across multiple devices or displays.

By generating a customized window 126 based on the user-defined area of interest 316, the content control module 116 provides a focused and efficient way for the user 108 to track specific information from the sporting event. This approach may reduce cognitive load by consolidating desired displayed information and conserve computational resources otherwise expended in foreground execution of the application 122.

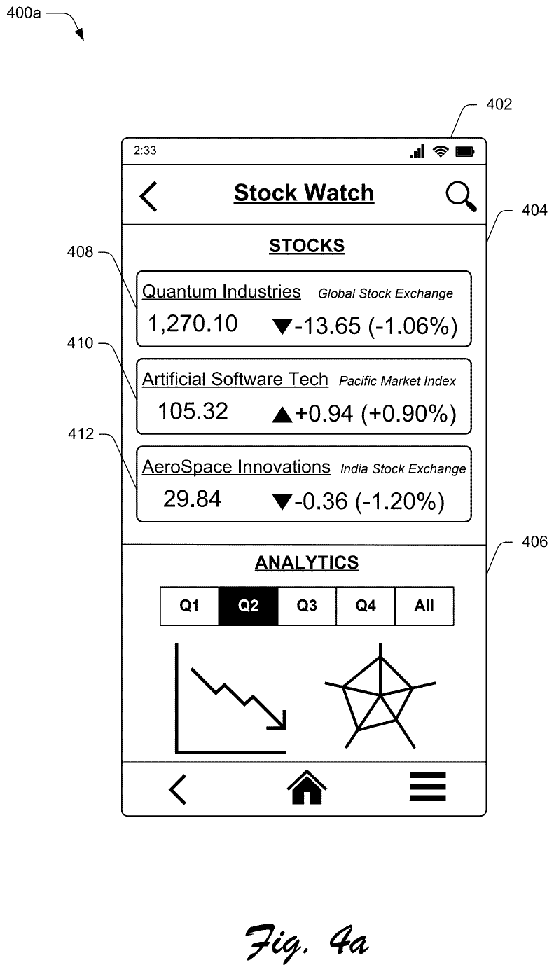

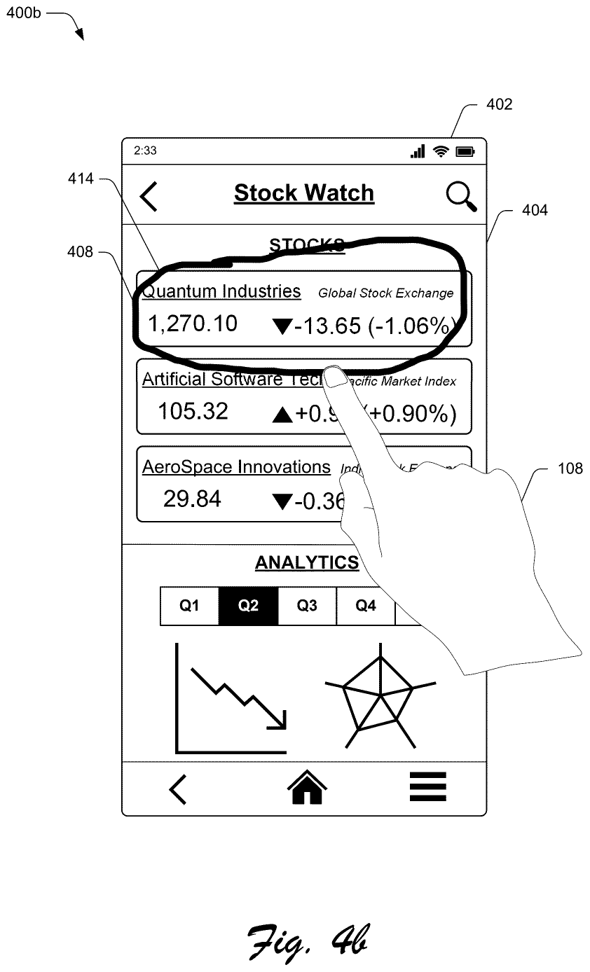

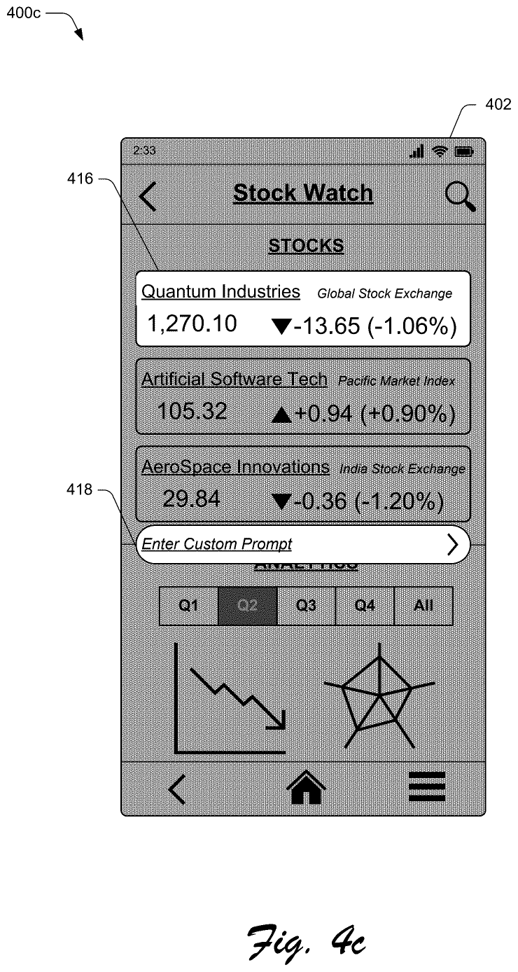

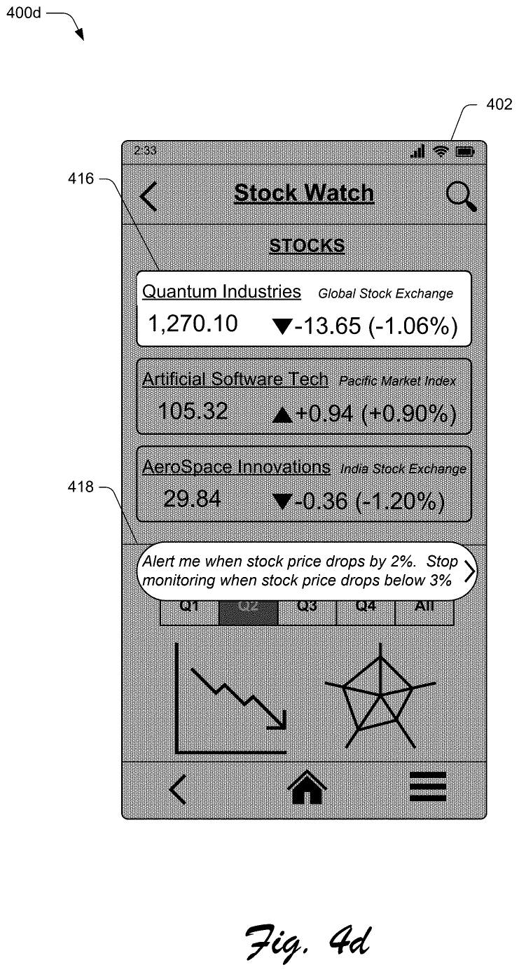

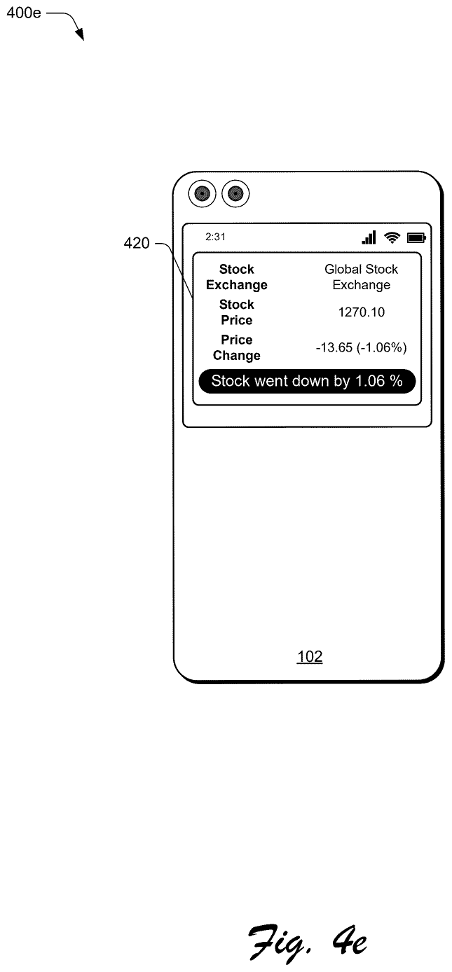

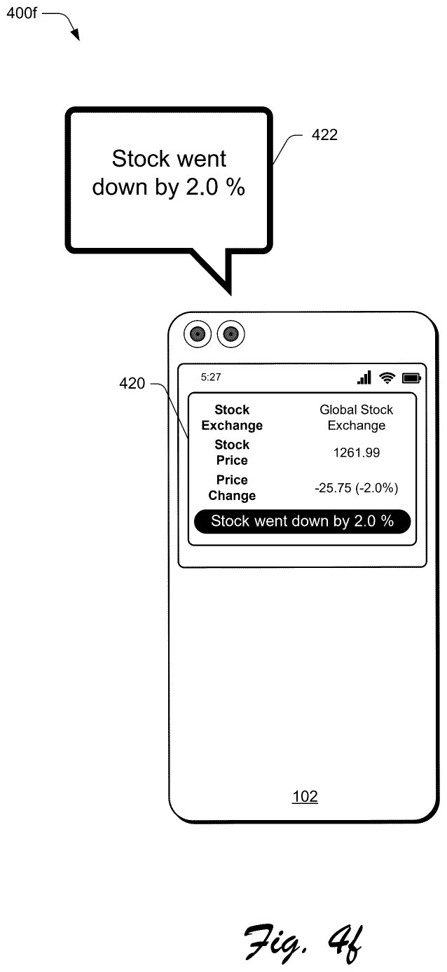

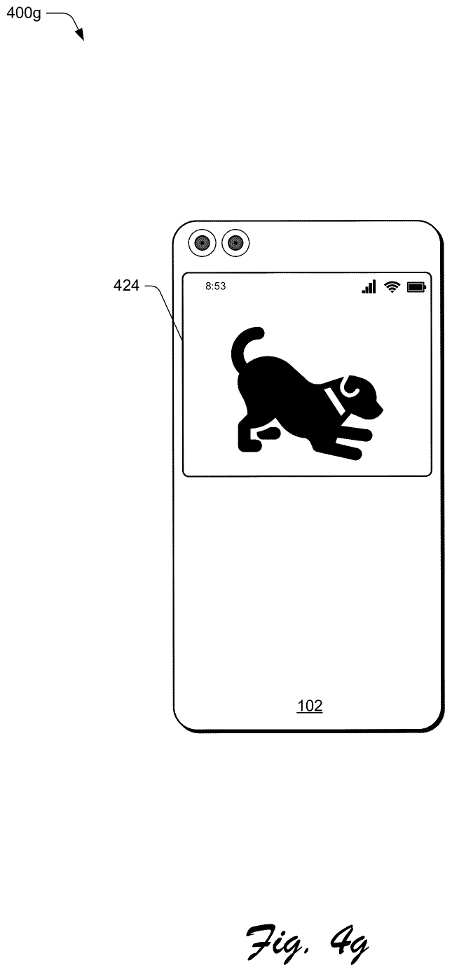

FIGS. 4a-4g depict example implementations 400a, 400b, 400c, 400d, 400e, 400f, and 400g for dynamic window generation based on a defined area of interest in which the window is based in part on a prompt in accordance with one or more implementations.

To begin in this example, FIG. 4a depicts an example implementation 400a that includes an interface 402 of a stock application. The interface 402 depicts a variety of information, such as a stock section 404 and an analytics section 406. The stock section 404 displays multiple stock graphics, including a first stock graphic 408, a second stock graphic 410, and a third stock graphic 412. Each stock graphic represents a different stock and displays relevant information such as company name, current price, market, and metrics associated with price change.

In this example, the user 108 desires to receive updates particular to the first stock. Accordingly, the input 202 includes a user input 414 to draw a boundary 204 around a portion of the application content 124 displayed in the interface 402. In this example, the user input 414 includes an action to draw the boundary 204 around the first stock graphic 408 using the input mechanisms 120, e.g., a touch screen, of the client device 102. As illustrated, the user input 414 intersects a portion of the first stock graphic 408 in several locations.

FIG. 4c depicts an example implementation 400c in which the boundary module 206 determines an area of interest 416 based on the boundary 204. The boundary module 206 may adjust the boundary 204 to align with content elements displayed within the boundary 204 in accordance with the techniques described herein. For instance, the boundary module 206 may analyze a document object model of the application 122 and/or leverage one or more visual recognition algorithms to identify UI elements that are spatially consistent with the user input 414. Additionally, FIG. 4c depicts a prompt field 418 that is presented to receive a prompt from the user 108. The prompt field 418 allows the user 108 to specify conditions for updating the window 126 and/or to generate notifications based on specified changes.

FIG. 4d depicts an example implementation 400d in which the content control module 116 receives a prompt in the prompt field 418. In this example, the prompt instructs the system 200 to generate a notification once the stock drops by 2%. The prompt also specifies to stop monitoring when the stock price drops below 3%. This user-specified condition allows for customized monitoring and alert configuration.

FIG. 4e depicts an example implementation 400e in which the window manager module 216 configures window content 420 for display in a window 126. In this example, the window 126 is a widget displayed on a rear display of the client device 102. The window manager module 216 may extract relevant information from the area of interest 416, such as the current stock price and change percentage, and format this information for display as the window content 420 in accordance with the techniques described herein. The window manager module 216 may further update the window 126, such as responsive to a detected change to the dynamic component 210 in the background application instance 214. This ensures that the window content 420 reflects current stock information without manually intervention or navigation to the application interface 402.

FIG. 4f depicts an example implementation 400f in which the stock price has dropped by 2%. In accordance with the user-specified condition received in the prompt field 418, the client device 102 generates an audio output 422. The audio output 422 serves as an audio notification that corresponds to the update in the dynamic component 210 and alerts the user 108 to the significant change in stock price without visual attention to the window 126.

FIG. 4g depicts an example implementation 400g in which a termination condition 220 is detected. In this example, the termination condition 220 is based on the prompt. For instance, when the stock price drops by 3%, the termination module 218 may detect this as a termination condition 220. In response, the content control module 116 may initiate a termination procedure to remove the window 126 from display and terminate the background application instance 214. As illustrated, the rear display no longer depicts the window 126 and instead depicts a home screen 424 with a background image of a dog. Thus, the automatic cleanup process as described herein maintain an uncluttered user interface and conserves system resources. Further, the prompt based window configuration techniques support a variety of customization options for data monitoring which enhances utility of the system 200.

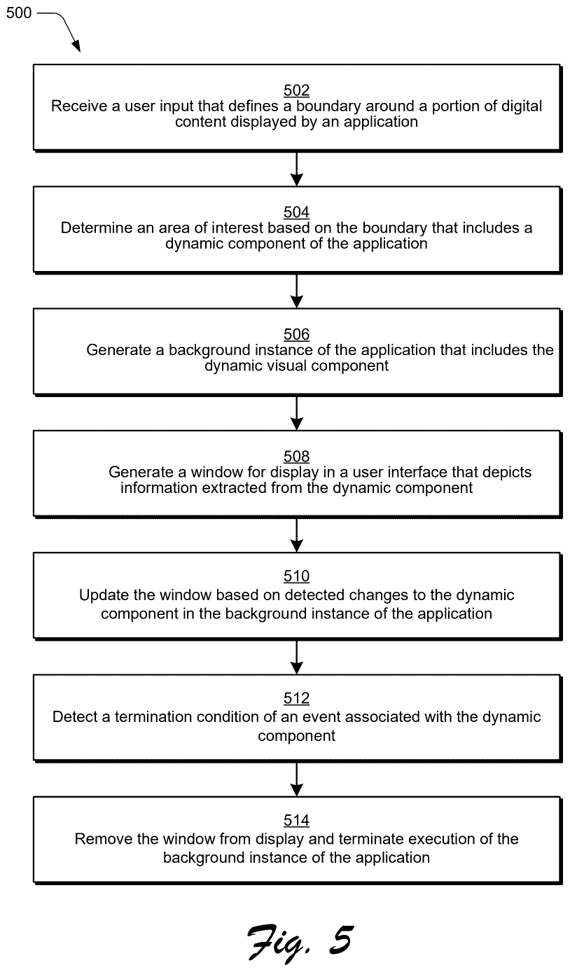

FIG. 5 illustrates a flow chart depicting an example method 500 for dynamic window generation based on a defined area of interest in accordance with one or more implementations.

At 502, a user input is received that defines a boundary around a portion of digital content displayed by an application of a client device 102. The input 202 may be received through the input mechanisms 120 of the client device 102, such as a touch screen or stylus input. For instance, the input 202 includes a stroke to substantially enclose a particular region of application content 124 displayed by the application 122.

At 504, an area of interest of the digital content is determined based on the boundary that includes a dynamic component of the application 122. The content control module 116, for instance, analyzes the input 202 to identify a particular region of the application content 124 to be represented by the window 126, e.g., a region that the user 108 wishes to monitor. The content control module 116 is further operable to adjust the boundary 204 to align with content elements displayed within the boundary 204.

At 506, a background instance of the application 122 is generated that includes the dynamic component 210. The content control module 116 may create the background application instance 214 to support monitoring of the dynamic component 210 while ceasing foreground execution of the application 122. This approach conserves computational resources of the client device 102 otherwise used to render the application content 124 for display.

At 508, a window 126 is generated for display in a user interface 118 of the client device 102 that depicts information extracted from the dynamic component 210. The window 126, for instance, provides a condensed view of the information from the area of interest 316 such as information extracted from the dynamic component 210. The window 126 can provide quick access to particular functionality and/or specific information and thus can be displayed in various locations of the user interface 118 such as on a home screen, lock screen, notification center, and so forth.

At 510, the window 126 is updated based on detected changes to the dynamic component 210 in the background instance of the application 122. The content control module 116 is operable to continuously monitor the background application instance 214 for changes and update the window content 128 accordingly. The content control module 116 can update the window 126 continuously and/or at various time intervals.

At 512, a termination condition 220 of an event associated with the dynamic component 210 is detected. The content control module 116 may monitor for various conditions that indicate to end the monitoring process. In some cases, the termination condition 220 may include an expiration of a predetermined time period. For example, the user 108 may specify a duration for which to monitor the dynamic component 210. Additionally or alternatively, the termination condition 220 is detected based on one or more detected changes to the application content 124, such as an indication that an event associated with the application content 124 has concluded.

In some cases, the termination condition 220 may include one or more of an end of the event, an arrival of a transportation mode to a destination, or a stock market close. For example, if the dynamic component 210 is related to a sports match, the termination condition 220 may be the end of the match. If the dynamic component 210 is tracking a transportation schedule, the termination condition 220 may be the arrival of a vehicle at its destination. For financial applications, the termination condition 220 may be the closing of the stock market.

At 514, the window 126 is removed from display and execution of the background instance of the application 122 is terminated. The content control module 116 can do so automatically and without user intervention responsive to detection of the termination condition 220. The content control module 116 may initiate this process to clean up system resources and maintain an uncluttered user interface 118.

Accordingly, implementation of the techniques described herein by the client device 102 provides a streamlined approach for users to monitor specific information from applications without foreground execution of the application or burdensome manual intervention. This method 500 may enhance user experience by allowing focused information tracking while further reducing device resource usage.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 6 illustrates various components of an example device 600 in which aspects of dynamic window generation based on a defined area of interest can be implemented. The example device 600 can be implemented as any of the devices described with reference to the previous FIGS. 1-5, such as any type of mobile device, mobile phone, mobile device, wearable device, tablet, computing, communication, entertainment, gaming, media playback, and/or other type of electronic device. For example, the client device 102 as shown and described with reference to FIGS. 1-5 may be implemented as the example device 600.

The device 600 includes communication transceivers 602 that enable wired and/or wireless communication of device data 604 with other devices. The device data 604 can include any of device identifying data, device location data, wireless connectivity data, and wireless protocol data. Additionally, the device data 604 can include any type of audio, video, and/or image data. Example communication transceivers 602 include wireless personal area network (WPAN) radios compliant with various IEEE 602.15 (Bluetooth™) standards, wireless local area network (WLAN) radios compliant with any of the various IEEE 602.11 (Wi-Fi™) standards, wireless wide area network (WWAN) radios for cellular phone communication, wireless metropolitan area network (WMAN) radios compliant with various IEEE 602.16 (WiMAX™) standards, and wired local area network (LAN) Ethernet transceivers for network data communication.

The device 600 may also include one or more data input ports 606 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 600 includes a processing system 608 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 610. The device 600 may further include any type of a system bus or other data and command transfer system that couples the various components within the device. A system bus can include any one or combination of different bus structures and architectures, as well as control and data lines.

The device 600 also includes computer-readable storage memory 612 (e.g., memory devices) that enable data storage, such as data storage devices that can be accessed by a computing device, and that provide persistent storage of data and executable instructions (e.g., software applications, programs, functions, and the like). Examples of the computer-readable storage memory 612 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 600 may also include a mass storage media device.

The computer-readable storage memory 612 provides data storage mechanisms to store the device data 604, other types of information and/or data, and various device applications 614 (e.g., software applications). For example, an operating system 616 can be maintained as software instructions with a memory device and executed by the processing system 608. The device applications may also include a device manager, such as any form of a control application, software application, signal-processing and control module, code that is native to a particular device, a hardware abstraction layer for a particular device, and so on. Computer-readable storage memory 612 represents media and/or devices that enable persistent and/or non-transitory storage of information in contrast to mere signal transmission, carrier waves, or signals per se. Computer-readable storage memory 612 do not include signals per se or transitory signals.

In this example, the device 600 includes a content control module 618 that implements aspects of dynamic window generation based on a defined area of interest and may be implemented with hardware components and/or in software as one of the device applications 614. In an example, the content control module 618 can be implemented as the content control module 116 described in detail above. In implementations, the content control module 618 may include independent processing, memory, and logic components as a computing and/or electronic device integrated with the device 600. The device 600 also includes digital content data 620 for implementing aspects of dynamic window generation based on a defined area of interest and may include data from and/or utilized by the content control module 618.

In this example, the example device 600 also includes a camera 622 and motion sensors 624, such as may be implemented in an inertial measurement unit (IMU). The motion sensors 624 can be implemented with various sensors, such as a gyroscope, an accelerometer, and/or other types of motion sensors to sense motion of the device. The various motion sensors 624 may also be implemented as components of an inertial measurement unit in the device.

The device 600 also includes a wireless module 626, which is representative of functionality to perform various wireless communication tasks. For instance, for the client device 102, the wireless module 626 can be leveraged to scan for and detect wireless networks, as well as negotiate wireless connectivity to wireless networks for the client device 102. The device 600 can also include one or more power sources 628, such as when the device is implemented as a mobile device. The power sources 628 may include a charging and/or power system, and can be implemented as a flexible strip battery, a rechargeable battery, a charged super-capacitor, and/or any other type of active or passive power source.

The device 600 also includes an audio and/or video processing system 630 that generates audio data for an audio system 632 and/or generates display data for a display system 634. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 636. In implementations, the audio system and/or the display system are integrated components of the example device. Alternatively, the audio system and/or the display system are external, peripheral components to the example device.

Although implementations of dynamic window generation based on a defined area of interest have been described in language specific to features and/or methods, the subject of the appended claims is not necessarily limited to the specific features or methods described. Rather, the features and methods are disclosed as example implementations of dynamic window generation based on a defined area of interest, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In some aspects, the techniques described herein relate to a client device including: at least one memory; and at least one processor coupled with the at least one memory and operable to cause the client device to: receive a user input that defines a boundary around a portion of digital content displayed by an application of the client device; determine an area of interest of the digital content based on the boundary that includes a dynamic visual component of the application; generate a background instance of the application that includes the dynamic visual component; and output a window for display in a user interface of the client device that depicts information extracted from the dynamic visual component in the background instance of the application.

In some aspects, the techniques described herein relate to a client device, wherein the user input includes an action to draw the boundary around the portion of digital content and the window is a widget displayed in the user interface.

In some aspects, the techniques described herein relate to a client device, wherein to determine the area of interest includes correlating the boundary to one or more objects represented by a document object model of the digital content.

In some aspects, the techniques described herein relate to a client device, wherein to determine the area of interest further includes leveraging a visual recognition algorithm to correlate visual properties of the one or more objects to a location of the boundary.

In some aspects, the techniques described herein relate to a client device, wherein the window is operable to update the information extracted from the dynamic visual component at a predetermined temporal interval.

In some aspects, the techniques described herein relate to a client device, wherein the window is operable to update the information extracted from the dynamic visual component responsive to a detected change to the dynamic visual component in the background instance of the application.

In some aspects, the techniques described herein relate to a client device, wherein the client device is further operable to stream information from the background instance of the application and apply one or more modifications to the information to configure the information for display by the window.

In some aspects, the techniques described herein relate to a client device, wherein the client device is further operable to output an audio notification that corresponds to an update to the dynamic visual component.

In some aspects, the techniques described herein relate to a client device, wherein the dynamic visual component is associated with an event and the client device is further operable to: detect a termination condition associated with the event; and remove, automatically and responsive to detection of the termination condition, the window from display and terminate the background instance of the application.

In some aspects, the techniques described herein relate to a method performed by a client device, the method including: receiving a user input that defines a boundary around a portion of digital content displayed by an application of the client device; determining an area of interest of the digital content based on the boundary that includes a dynamic component of the application; generating a window for display in a user interface of the client device that depicts information associated with the dynamic component; detecting an update to the dynamic component within a background instance of the application; and updating the window within the user interface based on the update to the dynamic component.

In some aspects, the techniques described herein relate to a method, wherein the user input includes an action to draw the boundary around the portion of digital content in a touch screen of the client device and the window is a widget displayed in the user interface.

In some aspects, the techniques described herein relate to a method, wherein the determining the area of interest includes adjusting the boundary to align with content elements displayed within the boundary.

In some aspects, the techniques described herein relate to a method, further including receiving a user-specified condition for updating the window; and updating the window responsive to occurrence of the user-specified condition.

In some aspects, the techniques described herein relate to a method, wherein the digital content depicts a sporting event and the window depicts a visual representation of a particular statistic associated with the sporting event.

In some aspects, the techniques described herein relate to a method, wherein the application is a transportation application and the window indicates when a particular transportation mode will reach a particular destination.

In some aspects, the techniques described herein relate to a method, further including: detecting a termination condition of an event associated with the dynamic component; and removing, automatically and responsive to detection of the termination condition, the window from display and terminating execution of the background instance of the application.

In some aspects, the techniques described herein relate to a system including: at least one memory; and at least one processor coupled to the at least one memory and operable to cause the system to: receive an input that defines a boundary around a portion of digital content associated with an event displayed by an application; determine an area of interest of the digital content based on the boundary that includes a dynamic visual component of the application; display a window in a user interface of a client device that updates information extracted from the dynamic visual component in a background instance of the application; detect a termination condition associated with the event; and remove, responsive to detection of the termination condition, the window from display by the client device.

In some aspects, the techniques described herein relate to a system, wherein the at least one processor is further operable to terminate execution of the background instance of the application responsive to detection of the termination condition.

In some aspects, the techniques described herein relate to a system, wherein the termination condition includes one or more of an end of the event, an arrival of a transportation mode to a destination, or a stock market close.

In some aspects, the techniques described herein relate to a system, wherein the termination condition includes an expiration of a predetermined time period.

1. A client device comprising:
at least one memory; and
at least one processor coupled with the at least one memory and operable to cause the client device to:
receive a user input that defines a boundary around a portion of digital content displayed by an application of the client device;
determine an area of interest of the digital content based on the boundary that includes a dynamic visual component of the application;
generate a background instance of the application that includes the dynamic visual component; and
output a window for display in a user interface of the client device that depicts information extracted from the dynamic visual component in the background instance of the application.

2. The client device of claim 1, wherein the user input includes an action to draw the boundary around the portion of digital content and the window is a widget displayed in the user interface.

3. The client device of claim 1, wherein to determine the area of interest includes correlating the boundary to one or more objects represented by a document object model of the digital content.

4. The client device of claim 3, wherein to determine the area of interest further includes leveraging a visual recognition algorithm to correlate visual properties of the one or more objects to a location of the boundary.

5. The client device of claim 1, wherein the window is operable to update the information extracted from the dynamic visual component at a predetermined temporal interval.

6. The client device of claim 1, wherein the window is operable to update the information extracted from the dynamic visual component responsive to a detected change to the dynamic visual component in the background instance of the application.

7. The client device of claim 1, wherein the client device is further operable to stream information from the background instance of the application and apply one or more modifications to the information to configure the information for display by the window.

8. The client device of claim 1, wherein the client device is further operable to output an audio notification that corresponds to an update to the dynamic visual component.

9. The client device of claim 1, wherein the dynamic visual component is associated with an event and the client device is further operable to:
detect a termination condition associated with the event; and
remove, automatically and responsive to detection of the termination condition, the window from display and terminate the background instance of the application.

10. A method performed by a client device, the method comprising:
receiving a user input that defines a boundary around a portion of digital content displayed by an application of the client device;
determining an area of interest of the digital content based on the boundary that includes a dynamic component of the application;
generating a window for display in a user interface of the client device that depicts information associated with the dynamic component;
detecting an update to the dynamic component within a background instance of the application; and
updating the window within the user interface based on the update to the dynamic component.

11. The method of claim 10, wherein the user input includes an action to draw the boundary around the portion of digital content in a touch screen of the client device and the window is a widget displayed in the user interface.

12. The method of claim 10, wherein the determining the area of interest includes adjusting the boundary to align with content elements displayed within the boundary.

13. The method of claim 10, further comprising receiving a user-specified condition for updating the window; and updating the window responsive to occurrence of the user-specified condition.

14. The method of claim 10, wherein the digital content depicts a sporting event and the window depicts a visual representation of a particular statistic associated with the sporting event.

15. The method of claim 10, wherein the application is a transportation application and the window indicates when a particular transportation mode will reach a particular destination.

16. The method of claim 10, further comprising:
detecting a termination condition of an event associated with the dynamic component; and
removing, automatically and responsive to detection of the termination condition, the window from display and terminating execution of the background instance of the application.

17. A system comprising:
at least one memory; and
at least one processor coupled to the at least one memory and operable to cause the system to:
receive an input that defines a boundary around a portion of digital content associated with an event displayed by an application;
determine an area of interest of the digital content based on the boundary that includes a dynamic visual component of the application;
display a window in a user interface of a client device that updates information extracted from the dynamic visual component in a background instance of the application;
detect a termination condition associated with the event; and
remove, responsive to detection of the termination condition, the window from display by the client device.

18. The system of claim 17, wherein the at least one processor is further operable to terminate execution of the background instance of the application responsive to detection of the termination condition.

19. The system of claim 17, wherein the termination condition includes one or more of an end of the event, an arrival of a transportation mode to a destination, or a stock market close.

20. The system of claim 17, wherein the termination condition includes an expiration of a predetermined time period.
